(19) United States
(12) Patent Application Publication
(10) Pub. No.: US 2024/0002655 A1
(43) Pub. Date: Jan. 4, 2024

(54) COFFEE STRETCH YARN WITH ACCELERATED BIODEGRADABILITY

(71) Applicant: Diego Klaus, Celebration, FL (US)

(72) Inventor: Diego Klaus, Celebration, FL (US)

(21) Appl. No.: 18/216,482

(22) Filed: Jun. 29, 2023

Related U.S. Application Data
(60) Provisional application No. 63/357,414, filed on Jun. 30, 2022.

(51) Int. Cl. C08L 67/02; A43B 1/14; A43B 1/025

(52) U.S. Cl. CPC C08L 67/02; A43B 1/14; A43B 1/025; C08L 2205/025; C08L 2207/20

(57) ABSTRACT

A sustainable textile yarn composition, method, and exemplary use of the sustainable textile yarn that addresses the need for sustainable and environmentally friendly materials in the textile industry. The invention encompasses a unique combination of recycled coffee grounds, recycled polyethylene terephthalate (PET) plastic, virgin PET, elastomer, and an anaerobic biodegradability acceleration agent to create a textile yarn that is capable of degrading in both aerobic and anaerobic environments.

### CROSS-REFERENCE TO RELATED APPLICATION(S)

This application claims the benefit of priority pursuant to 35 U.S.C. § 119(e) of U.S. Provisional Patent Application Ser. No. 63/357,414, entitled “Coffee Stretch Yarn with Accelerated Biodegradability”, filed Jun. 30, 2022. Which is hereby incorporated by reference in its entirety for all purposes.

### FIELD OF THE INVENTION

The present invention relates to sustainable textiles with enhanced biodegradability.

### BACKGROUND

Conventional textile materials often contribute to the accumulation of non-biodegradable waste and the depletion of natural resources. The reliance on virgin materials, such as petroleum-based plastics and non-renewable fibers, has led to significant environmental concerns. As a result, there is a growing demand for textile products that exhibit enhanced biodegradability while maintaining desirable properties and performance.

To address these challenges, the present invention proposes a textile yarn composition that incorporates recycled coffee grounds, recycled polyethylene terephthalate (PET) plastic, virgin PET, elastomer, and an anaerobic biodegradability acceleration agent. This unique combination of components allows for the production of a textile yarn that demonstrates biodegradability characteristics in both aerobic and anaerobic environments.

The use of recycled coffee grounds as a constituent of the textile yarn composition provides numerous environmental benefits. Coffee grounds are abundantly available as waste material from coffee production and consumption. By transforming coffee grounds into a usable fiber, this invention promotes the efficient utilization of this readily available, renewable resource while diverting a significant waste stream from landfills.

In addition to recycled coffee grounds, the composition includes recycled PET plastic. PET is commonly used in the production of various products, including plastic bottles. However, improper disposal of PET plastics contributes to environmental pollution. By incorporating recycled PET plastic into the textile yarn composition, the invention promotes the recycling and repurposing of these materials, reducing their negative environmental impact.

The combination of recycled materials, virgin PET, and elastomer in the textile yarn composition ensures a balance between sustainability and performance. The virgin PET and elastomer components provide strength, elasticity, and desired textile properties, while the recycled materials contribute to the overall environmental sustainability of the product.

Furthermore, the textile yarn composition incorporates an anaerobic biodegradability acceleration agent, such as a glutamic acid compound and a biological enzyme. This agent facilitates the breakdown of the yarn in both aerobic and anaerobic environments, including landfills and composting facilities. By enabling biodegradation in various environments, the invention aims to minimize the accumulation of textile waste and reduce the overall environmental impact associated with textile disposal.

Thus, the textile yarn composition presented in this invention offers a sustainable alternative to conventional textile materials. By incorporating recycled coffee grounds, recycled PET plastic, virgin PET, elastomer, and an anaerobic biodegradability acceleration agent, the invention addresses the need for eco-friendly materials in the textile industry while promoting a circular economy and minimizing waste generation.

### SUMMARY OF THE INVENTION

The invention disclosed herein provides a sustainable yarn textile. The sustainable yarn textile comprises processed coffee grounds comprising a percentage of formulation of 30% by weight, polyethylene terephthalate comprising a percentage of formulation of 62% by weight, an elastomer comprising a percentage of formulation of 5% by weight, and an anaerobic biodegradability acceleration agent comprising a percentage of formulation of 3% by weight.

The invention disclosed herein also provides a method for creating a sustainable yarn textile for use in clothing, shoes, and apparel, capable of both anaerobic and aerobic degradation. The method comprises providing processed coffee grounds as a base for a yarn textile, portioning said coffee grounds to a percentage of formulation of 30% by weight, adding polyethylene terephthalate, at a percentage of formulation of 62% by weight, adding in an elastomer, at a percentage of formulation of 5% by weight, adding in an anaerobic biodegradability acceleration agent, a percentage of formulation of 3% by weight, and processing said coffee grounds, polyethylene terephthalate, elastomer, and anaerobic biodegradability agent into a yarn textile.

The invention disclosed herein further provides a sustainable article of footwear. This article of footwear comprises an upper constructed of a sustainable yarn textile, an insole comprising a bio-based foam footbed, and a sole of a biodegradable EVA foam. The sustainable yarn textile comprises processed coffee grounds comprising a percentage of formulation of 30% by weight, polyethylene terephthalate comprising a percentage of formulation of 62% by weight, an elastomer comprising a percentage of formulation of 5% by weight, and an anaerobic biodegradability acceleration agent comprising a percentage of formulation of 3% by weight.

It is an object of the present invention to provide a system to provide a textile that reduces the environmental impact of sourcing raw materials of clothing and footwear.

It is yet another object of the present invention is to provide a textile that may break down under both aerobic and anaerobic decomposition, thus allowing flexibility in a final decomposition location (such as landfill or composting facility) at its end of life.

It is a further object to provide a high-performance textile that provides an ultra-light textile that is machine washable, antimicrobial, vegan friendly, breathable, UV protective, and provides odor control, while maintaining the sustainability and biodegradability of the textile.

The drawings and specific descriptions of the drawings, as well as any specific or alternative embodiments discussed, are intended to be read in conjunction with the entirety of this disclosure. The invention may be embodied in many different forms and should not be construed as being limited to the embodiments set forth herein; rather, these embodiments are provided by way of illustration only and so that this disclosure will be thorough, complete and fully convey understanding to those skilled in the art. The above and yet other objects and advantages of the present invention will become apparent from the hereinafter set forth Brief Description of the Drawings, Detailed Description of the Invention, and Claims appended herewith.

### BRIEF DESCRIPTION OF THE DRAWINGS

FIG. 1 illustrates a table of materials for a sustainable yarn textile.

FIG. 2 illustrates a table of materials for a sustainable yarn textile.

FIG. 3 illustrates a flowchart of the method for creating a sustainable yarn textile.

FIG. 4 illustrates a perspective front top view of a pair of athletic shoes incorporating a sustainable yarn textile.

FIG. 5 illustrates a side view of the athletic shoe of FIG. 4 on the foot of a user.

FIG. 6 illustrates an exploded view of the shoe of FIG. 4.

### DETAILED DESCRIPTION OF THE INVENTION

The disclosure herein provides an invention relating to a textile yarn composition that addresses the need for sustainable and environmentally friendly materials in the textile industry. The invention encompasses a unique combination of recycled coffee grounds, recycled polyethylene terephthalate (PET) plastic, virgin PET, elastomer, and an anaerobic biodegradability acceleration agent to create a textile yarn that is capable of degrading in both aerobic and anaerobic environments.

As stated above, conventional textile materials often contribute to the accumulation of non-biodegradable waste and the depletion of natural resources. The reliance on virgin materials, such as petroleum-based plastics and non-renewable fibers, has led to significant environmental concerns. As a result, there is a growing demand for textile products that exhibit enhanced biodegradability while maintaining desirable properties and performance.

To address these challenges, the present invention proposes a textile yarn composition that incorporates recycled coffee grounds, recycled polyethylene terephthalate (PET) plastic, virgin PET, elastomer, and an anaerobic biodegradability acceleration agent. This unique combination of components allows for the production of a textile yarn that demonstrates biodegradability characteristics in both aerobic and anaerobic environments.

The use of recycled coffee grounds as a constituent of the textile yarn composition provides numerous environmental benefits. Coffee grounds are abundantly available as waste material from coffee production and consumption. By transforming coffee grounds into a usable fiber, this invention promotes the efficient utilization of this readily available, renewable resource while diverting a significant waste stream from landfills.

In addition to recycled coffee grounds, the composition includes recycled PET plastic. PET is commonly used in the production of various products, including plastic bottles. However, improper disposal of PET plastics contributes to environmental pollution. By incorporating recycled PET plastic into the textile yarn composition, the invention promotes the recycling and repurposing of these materials, reducing their negative environmental impact.

The combination of recycled materials, virgin PET, and elastomer in the textile yarn composition ensures a balance between sustainability and performance. The virgin PET and elastomer components provide strength, elasticity, and desired textile properties, while the recycled materials contribute to the overall environmental sustainability of the product.

Furthermore, the textile yarn composition incorporates an anaerobic biodegradability acceleration agent, such as a glutamic acid compound and a biological enzyme. This agent facilitates the breakdown of the yarn in both aerobic and anaerobic environments, including landfills and composting facilities. By enabling biodegradation in various environments, the invention aims to minimize the accumulation of textile waste and reduce the overall environmental impact associated with textile disposal.

The material provides numerous advantages over standard textile properties. The materials are biodegradable, sustainable, ultralight, breathable, vegan friendly, stain and dirt proof, machine washable, and fast drying. In addition, the fabric is antibacterial and provides odor control. The recycled coffee component contains natural antibacterial properties: Coffee contains certain chemical compounds, such as caffeine and phenols, that have been found to possess antimicrobial properties. These compounds have the ability to inhibit the growth and survival of bacteria. Extraction and incorporation into textiles: During the recycling process, coffee grounds can be treated to extract these beneficial compounds. Once extracted, they can be incorporated into the fabric during the textile manufacturing process. This can be done by either coating the fibers with a coffee-based solution or by blending coffee grounds with the textile fibers directly. Contact with bacteria: When the textile comes into contact with bacteria, the antibacterial compounds present in the coffee can act against the microorganisms. The caffeine and phenols can disrupt the bacterial cell membranes, interfere with their metabolism, and inhibit their growth. As a result, the bacterial population on the textile may be reduced.

The coffee stretch yarn with accelerated biodegradability of the present invention includes measurements which may be approximations, it should be appreciated by those skilled in the art that the measurements are approximate, and the formulation may be modified without deviating from the claimed invention so long as the modifications do not substantially change the synthesized material. Therefore, references to “approximate” components and “about” measurements should be viewed as measurements with a reasonable degree of flexibility, as would be understood in the art, and not rigidly applied measurements. As such, a person of sufficient skill in the art would understand the meets and bounds of the required measurements.

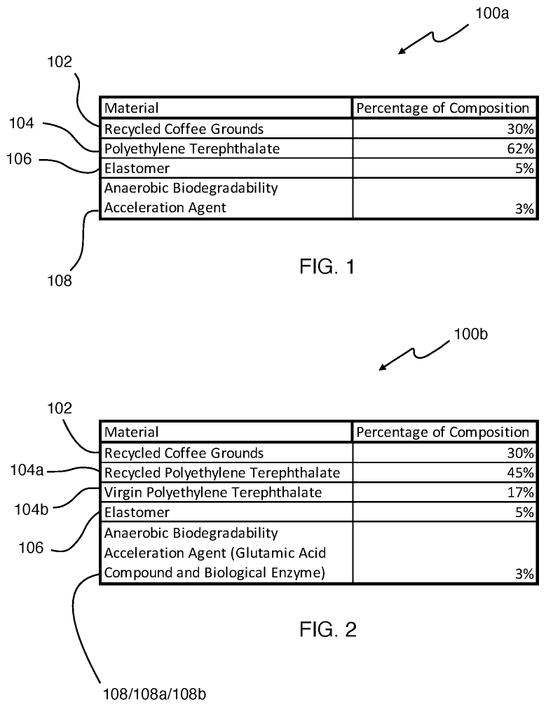

The coffee stretch yarn with accelerated biodegradability of the present invention may be used to provide a system to provide a textile that reduces the environmental impact of sourcing raw materials of clothing and footwear, provide a textile that may break down under both aerobic and anaerobic decomposition, thus allowing flexibility in a final decomposition location (such as landfill or composting facility) at its end of life, and provide an ultra-light textile that is machine washable, antimicrobial, vegan friendly, breathable, UV protective, and provides odor control, while maintaining the sustainability and biodegradability of the textile. This system and method are particularly shown in FIGS. 1-3.

FIGS. 1 and 2 illustrate tables of components of the sustainable yarn textile.

In an exemplary embodiment, invention disclosed herein provides a sustainable yarn textile 100a/100b. The sustainable yarn textile 100a/100b comprises processed coffee grounds 102 comprising a percentage of formulation of approximately 30% by weight, polyethylene terephthalate 104 comprising a percentage of formulation of approximately 62% by weight, an elastomer 106 comprising a percentage of formulation of approximately 5% by weight, and an anaerobic biodegradability acceleration agent 108 comprising a percentage of formulation of approximately 3% by weight.

In some embodiments, the polyethylene terephthalate 104, at a percentage of formulation of approximately 62% by weight includes recycled polyethylene terephthalate 104a and virgin polyethylene terephthalate 104b. The recycled polyethylene terephthalate 104a comprises about 72.6% of the amount of polyethylene terephthalate 104, or approximately 45% of an overall formulation of said coffee grounds 102, polyethylene terephthalate 104, elastomer 106, and anaerobic biodegradability agent 108. The virgin polyethylene terephthalate 104b comprises about 27.4% of the amount of polyethylene terephthalate 104, or approximately 17% of an overall formulation of said coffee grounds 102, polyethylene terephthalate 104, elastomer 106, and anaerobic biodegradability agent 108.

In most embodiments, the coffee grounds 102 are sourced from recycled coffee grounds, and the anaerobic biodegradability acceleration agent 108 comprises a glutamic acid compound 108a and a biological enzyme 108b.

While the above embodiment includes approximations in the measurements, it should be appreciated that another exemplary embodiment includes precise measurements, and thus, another exemplary embodiment of the invention provides a sustainable yarn textile, consisting of processed coffee grounds 102 comprising a percentage of formulation of 30% by weight, polyethylene terephthalate 104 comprising a percentage of formulation of 62% by weight, an elastomer 106 comprising a percentage of formulation of 5% by weight and an anaerobic biodegradability acceleration agent 108 comprising a percentage of formulation of 3% by weight.

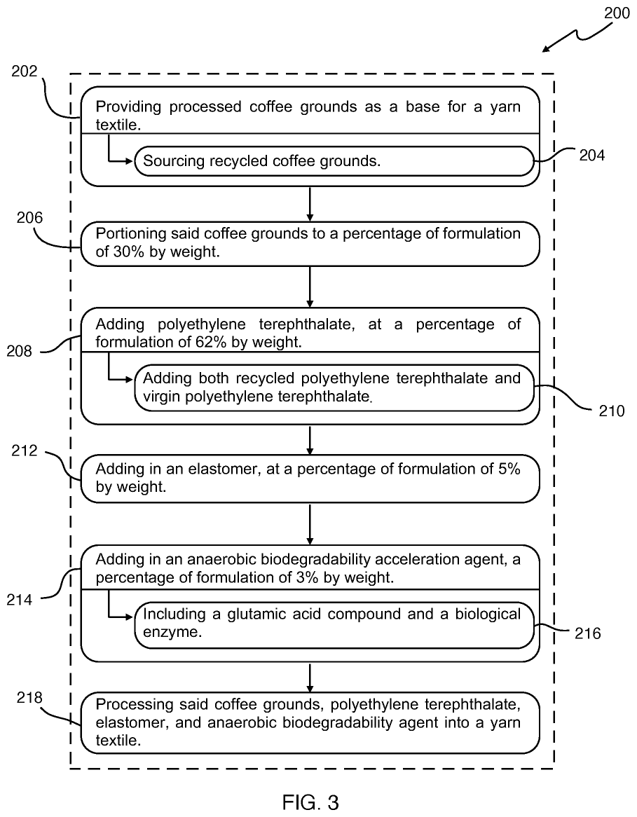

FIG. 3 illustrates a flowchart of the method 200 for creating a sustainable yarn textile for use in clothing, shoes, and apparel, capable of both anaerobic and aerobic degradation.

In the exemplary embodiment, the invention disclosed herein provides a method 200 for creating a sustainable yarn textile 100a/100b for use in clothing, shoes, and apparel, capable of both anaerobic and aerobic degradation. The method 200 comprises providing 202 processed coffee grounds 102 as a base for a yarn textile 100a/100b, portioning 206 said coffee grounds 102 to a percentage of formulation of approximately 30% by weight, adding 208 polyethylene terephthalate 104, at a percentage of formulation of approximately 62% by weight, adding in 212 an elastomer 106, at a percentage of formulation of approximately 5% by weight, adding in 214 an anaerobic biodegradability acceleration agent 108, a percentage of formulation of approximately 3% by weight, and processing 218 said coffee grounds 102, polyethylene terephthalate 104, elastomer 106, and anaerobic biodegradability agent 108 into a yarn textile 100a/100b.

In some embodiments of the method 200 for creating a sustainable yarn textile 100a/100b for use in clothing, shoes, and apparel, capable of both anaerobic and aerobic degradation, the step of adding 208 polyethylene terephthalate 104, at a percentage of formulation of approximately 62% by weight includes adding 210 both recycled polyethylene terephthalate 104a and virgin polyethylene terephthalate 104b. The recycled polyethylene terephthalate 104a comprises about 72.6% of the amount of polyethylene terephthalate 104, or approximately 45% of an overall formulation of said coffee grounds 102, polyethylene terephthalate 104, elastomer 106, and anaerobic biodegradability agent 108. The virgin polyethylene terephthalate 104b comprises about 27.4% of the amount of polyethylene terephthalate 104, or approximately 17% of an overall formulation of said coffee grounds 102, polyethylene terephthalate 104, elastomer 106, and anaerobic biodegradability agent 108.

In most embodiments, the method 200 includes sourcing 204 the coffee grounds from recycled coffee grounds 102, and selecting 216 the anaerobic biodegradability acceleration agent 108 to be a glutamic acid compound 108a and a biological enzyme 108b.

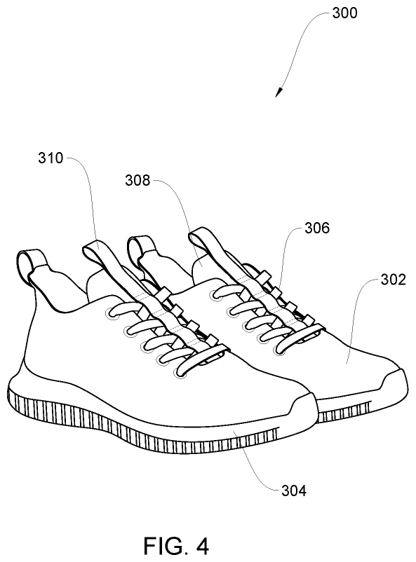

In yet another exemplary embodiment, the invention disclosed herein further provides a sustainable article of footwear 300. An example of an application in footwear 300 may be seen in FIGS. 4-6.

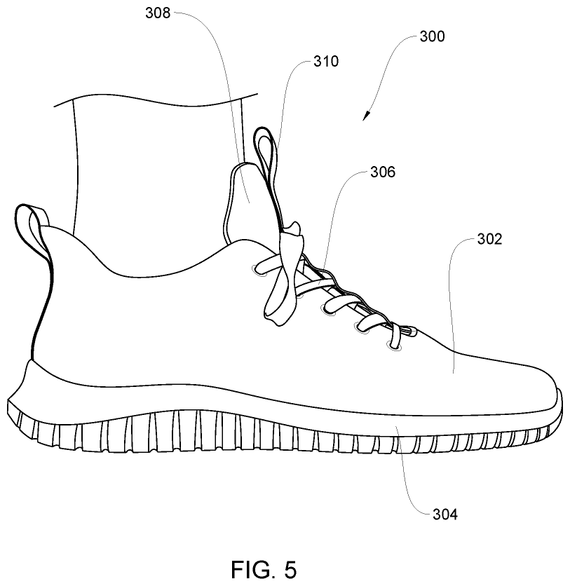

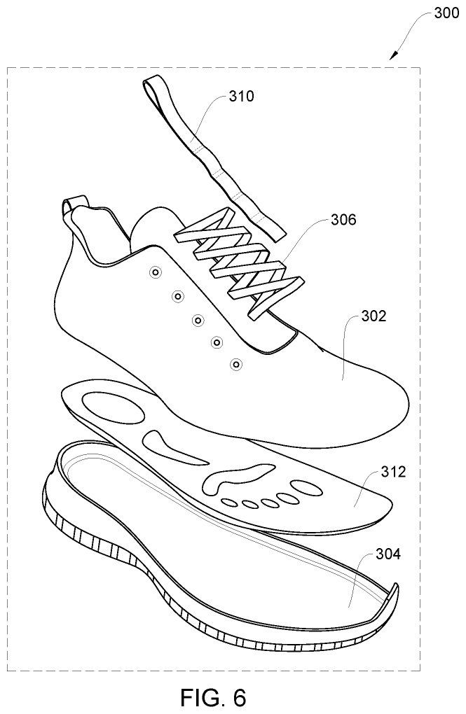

FIG. 4 illustrates a perspective view of a pair of athletic shoes 300. FIG. 5 illustrates a side view of an athletic shoe 300 on a user. FIG. 6 illustrates an exploded view of an exemplary athletic shoe 300.

This article of footwear 300 comprises an upper 302 constructed of a sustainable yarn textile 100a/100b, an insole 312 comprising a bio-based foam footbed, and a sole 304 of a biodegradable EVA foam. The sustainable yarn textile 100a/100b comprises processed coffee grounds 102 comprising a percentage of formulation of approximately 30% by weight, polyethylene terephthalate 104/104a/104b comprising a percentage of formulation of approximately 62% by weight, an elastomer 106 comprising a percentage of formulation of approximately 5% by weight, and an anaerobic biodegradability acceleration agent 108/108a/108b comprising a percentage of formulation of approximately 3% by weight.

A biodegradable EVA foam shoe sole 304 refers to a sole made from a type of foam called Ethylene Vinyl Acetate (EVA) that is designed to break down and decompose naturally over time. EVA is a synthetic material which may be used in shoe manufacturing due to its lightweight, flexible, and cushioning properties. Traditional EVA foam is not biodegradable because it consists of petroleum-based polymers that do not break down easily in the environment. However, by modifying the composition of EVA foam, a biodegradable alternative is created.

Biodegradable EVA foam soles are made by incorporating special additives into the material during the manufacturing process. These additives can be derived from natural sources, such as plant-based or bio-based materials. They help facilitate the decomposition of the foam when exposed to environmental conditions. The foam breaks down through microbial activity, oxidation, or other natural processes. This allows the sole to gradually degrade into smaller pieces and eventually disintegrate, reducing its environmental impact. The timeframe for biodegradable EVA foam to decompose can vary depending on environmental factors, such as temperature, humidity, and microbial activity. In some cases, it may take several months to a few years for the sole to completely break down. However, it's important to note that the decomposition rate can vary, and certain conditions may be required for effective degradation.

In some embodiments, the polyethylene terephthalate 104 material of said upper 302 constructed of a sustainable yarn textile 100a/100b, at a percentage of formulation of 62% by weight includes recycled polyethylene terephthalate 104a and virgin polyethylene terephthalate 104b. The recycled polyethylene terephthalate 104a comprises about 72.6% of the amount of polyethylene terephthalate, or approximately 45% of an overall formulation of said coffee grounds 102, polyethylene terephthalate 104, elastomer 106, and anaerobic biodegradability agent 108. The virgin polyethylene terephthalate 104b comprises about 27.4% of the amount of polyethylene terephthalate 104, or approximately 17% of an overall formulation of said coffee grounds 102, polyethylene terephthalate 104, elastomer 106, and anaerobic biodegradability agent 108.

In most embodiments, the coffee grounds are sourced from recycled coffee grounds 102, and the anaerobic biodegradability acceleration agent 108 comprises a glutamic acid compound 108a and a biological enzyme 108b.

As stated above, the coffee stretch yarn with accelerated biodegradability of the present invention includes measurements which may be approximations, it should be appreciated by those skilled in the art that the measurements are approximate, and the formulation may be modified without deviating from the claimed invention so long as the modifications do not substantially change the synthesized material. Therefore, references to “approximate” components and “about” measurements should be viewed as measurements with a reasonable degree of flexibility, as would be understood in the art, and not rigidly applied measurements. As such, a person of sufficient skill in the art would understand the meets and bounds of the required measurements.

While there has been shown and described above the preferred embodiments of the instant invention it is to be appreciated that the invention may be embodied otherwise than is herein specifically shown and described and that certain changes may be made in the form and arrangement of the parts and compositions without departing from the underlying ideas or principles of this invention as set forth in the Claims appended herewith.

I claim:

1. A sustainable yarn textile, comprising:
processed coffee grounds comprising a percentage of formulation of approximately 30% by weight;
polyethylene terephthalate comprising a percentage of formulation of approximately 62% by weight;
an elastomer comprising a percentage of formulation of approximately 5% by weight; and
an anaerobic biodegradability acceleration agent comprising a percentage of formulation of approximately 3% by weight.

2. The sustainable yarn textile, as recited in claim 1, wherein said polyethylene terephthalate, at a percentage of formulation of approximately 62% by weight includes:
recycled polyethylene terephthalate and virgin polyethylene terephthalate;
whereby said recycled polyethylene terephthalate comprises about 72.6% of the amount of polyethylene terephthalate, or approximately 45% of an overall formulation of said coffee grounds, polyethylene terephthalate, elastomer, and anaerobic biodegradability agent; and
whereby said virgin polyethylene terephthalate comprises about 27.4% of the amount of polyethylene terephthalate, or approximately 17% of an overall formulation of said coffee grounds, polyethylene terephthalate, elastomer, and anaerobic biodegradability agent.

3. The sustainable yarn textile, as recited in claim 1, wherein said coffee grounds are sourced from recycled coffee grounds.

4. The sustainable yarn textile, as recited in claim 1, wherein said anaerobic biodegradability acceleration agent comprises a glutamic acid compound and a biological enzyme.

5. A method for creating a sustainable yarn textile for use in clothing, shoes, and apparel, capable of both anaerobic and aerobic degradation, comprising:
providing processed coffee grounds as a base for a yarn textile;
portioning said coffee grounds to a percentage of formulation of approximately 30% by weight;
adding polyethylene terephthalate, at a percentage of formulation of approximately 62% by weight;
adding in an elastomer, at a percentage of formulation of approximately 5% by weight;
adding in an anaerobic biodegradability acceleration agent, a percentage of formulation of approximately 3% by weight; and
processing said coffee grounds, polyethylene terephthalate, elastomer, and anaerobic biodegradability agent into a yarn textile.

6. The method for creating a sustainable yarn textile for use in clothing, shoes, and apparel, capable of both anaerobic and aerobic degradation, as recited in claim 5, wherein said step of adding polyethylene terephthalate, at a percentage of formulation of approximately 62% by weight includes:
adding both recycled polyethylene terephthalate and virgin polyethylene terephthalate;
whereby said recycled polyethylene terephthalate comprises about 72.6% of the amount of polyethylene terephthalate, or approximately 45% of an overall formulation of said coffee grounds, polyethylene terephthalate, elastomer, and anaerobic biodegradability agent; and
whereby said virgin polyethylene terephthalate comprises about 27.4% of the amount of polyethylene terephthalate, or approximately 17% of an overall formulation of said coffee grounds, polyethylene terephthalate, elastomer, and anaerobic biodegradability agent.

7. The method for creating a sustainable yarn textile for use in clothing, shoes, and apparel, capable of both anaerobic and aerobic degradation, as recited in claim 5, wherein said coffee grounds are sourced from recycled coffee grounds.

8. The method for creating a sustainable yarn textile for use in clothing, shoes, and apparel, capable of both anaerobic and aerobic degradation, as recited in claim 5, wherein said anaerobic biodegradability acceleration agent comprises a glutamic acid compound and a biological enzyme.

9. A sustainable article of footwear, comprising:
an upper constructed of a sustainable yarn textile, wherein said sustainable yarn textile comprises:
processed coffee grounds comprising a percentage of formulation of approximately 30% by weight;
polyethylene terephthalate comprising a percentage of formulation of approximately 62% by weight;
an elastomer comprising a percentage of formulation of approximately 5% by weight; and
an anaerobic biodegradability acceleration agent comprising a percentage of formulation of approximately 3% by weight;
an insole comprising a bio-based foam footbed; and
a sole of a biodegradable EVA foam.

10. The sustainable article of footwear, as recited in claim 9, wherein said polyethylene terephthalate material of said upper constructed of a sustainable yarn textile, at a percentage of formulation of approximately 62% by weight includes:
recycled polyethylene terephthalate and virgin polyethylene terephthalate;
whereby said recycled polyethylene terephthalate comprises about 72.6% of the amount of polyethylene terephthalate, or approximately 45% of an overall formulation of said coffee grounds, polyethylene terephthalate, elastomer, and anaerobic biodegradability agent; and
whereby said virgin polyethylene terephthalate comprises about 27.4% of the amount of polyethylene terephthalate, or approximately 17% of an overall formulation of said coffee grounds, polyethylene terephthalate, elastomer, and anaerobic biodegradability agent.

11. The sustainable article of footwear, as recited in claim 9, wherein said coffee grounds material of said upper constructed of a sustainable yarn textile is sourced from recycled coffee grounds.

12. The sustainable article of footwear, as recited in claim 9, wherein said anaerobic biodegradability acceleration agent of said upper constructed of a sustainable yarn textile comprises a glutamic acid compound and a biological enzyme.

13. A sustainable yarn textile, consisting of:
processed coffee grounds comprising a percentage of formulation of 30% by weight;
polyethylene terephthalate comprising a percentage of formulation of 62% by weight;
an elastomer comprising a percentage of formulation of 5% by weight; and
an anaerobic biodegradability acceleration agent comprising a percentage of formulation of 3% by weight.

14. The sustainable yarn textile, as recited in claim 1, wherein said polyethylene terephthalate, at a percentage of formulation of 62% by weight is composed of:
recycled polyethylene terephthalate and virgin polyethylene terephthalate;
whereby said recycled polyethylene terephthalate comprises about 72.6% of the amount of polyethylene terephthalate, or 45% of an overall formulation of said coffee grounds, polyethylene terephthalate, elastomer, and anaerobic biodegradability agent; and
whereby said virgin polyethylene terephthalate comprises about 27.4% of the amount of polyethylene terephthalate, or 17% of an overall formulation of said coffee grounds, polyethylene terephthalate, elastomer, and anaerobic biodegradability agent.

15. The sustainable yarn textile, as recited in claim 1, wherein said coffee grounds are sourced from recycled coffee grounds.

16. The sustainable yarn textile, as recited in claim 1, wherein said anaerobic biodegradability acceleration agent comprises a glutamic acid compound and a biological enzyme.
